(19) United States
(12) Patent Application Publication
(10) Pub. No.: US 2005/0071040 A1
(43) Pub. Date: Mar. 31, 2005

(54) System and method of producing wallpaper in a retail location

(76) Inventor: Gene Kirila II, Transfer, PA (US)

Correspondence Address: BENESCH, FRIEDLANDER, COPLAN & ARONOFF LLP;ATTN: IP DEPARTMENT DOCKET CLERK, 2300 BP TOWER, 200 PUBLIC SQUARE, CLEVELAND, OH, 44114, US

(21) Appl. No.: 10/712,984

(22) Filed: Nov. 12, 2003

Related U.S. Application Data
(60) Provisional application No. 60/425,500, filed on Nov. 12, 2002.

(51) Int. Cl. G06F 19/00

(52) U.S. Cl. 700/130

(57) ABSTRACT

An example wallpaper production method is provided. An example method may include displaying a plurality of wallpaper designs in a manner suitable for consumer viewing, receiving an order for a selected wallpaper design from the consumer, and printing, at the retail location, the selected wallpaper design onto a suitable substrate to thereby produce the wallpaper.

### CROSS-REFERENCE TO RELATED APPLICATION

This application claims the benefit of priority of U.S. Provisional Application No. 60/425,500 filed on Nov. 12, 2002, which is hereby incorporated by reference in its entirety herein.

### BACKGROUND

Among the variety of ways of decorating walls in both dwellings and commercial enterprises is the use of wall coverings, particularly wallpaper. Traditionally, a consumer travels to a wallpaper retailer, views a limited selection of wallpaper designs, selects a design, and purchases a desired amount of the wallpaper (if the selected wallpaper is in stock) or orders the desired amount of wallpaper (if the selected wallpaper is not in stock).

Under this traditional method, retailers must deal with issues relating to storage, inventory control, and selection of wallpaper designs. Although wallpaper is available in an infinite number of designs or patterns, wallpaper retailers are unable to stock a large number of wallpaper designs in inventory due to storage and cost constraints. If a particular design or the required amount of wallpaper is not in inventory, the wallpaper must be shipped separately to the retailer and the consumer must wait a number of days or weeks before returning to the store to pick up the wallpaper. Delays in obtaining the wallpaper often results in consumer dissatisfaction. The wallpaper retailer must also attempt to anticipate which designs consumers are most likely to purchase, while also providing a wide variety of designs for consumers to select from. If a particular design of wallpaper is not popular, the wallpaper retailer must sell the wallpaper at a lower price, decreasing profitability.

Retailers may also provide samples of the wallpaper at the retailer's place of business. Consumers must travel to the retailer to view the samples. Many consumers may want to take the sample from the retailer's place of business to evaluate whether the wallpaper is aesthetically pleasing at the site of installation. However, consumers may not be able to remove the sample for a variety of reasons, such as, if the retailer does not have multiple samples of the particular design. If the consumer is able to take a sample from the retailer, the sample may be too small or found within a book of samples, making it difficult for the consumer to determine if a design is aesthetically pleasing. Or, the retailer may require the consumer to leave a deposit, which is returned when the sample is returned to the retailer.

### BRIEF DESCRIPTION OF THE DRAWINGS

The accompanying drawings, which are incorporated in and constitute a part of the specification, illustrate various example systems, methods, and so on that illustrate various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

FIG. 1 illustrates an example method of producing wallpaper at a retailer location.

FIG. 2 illustrates another example method of producing wallpaper at a retailer location.

FIG. 3 illustrates one example method of producing customized wallpaper at a retailer location.

FIG. 4 illustrates another example method of producing customized wallpaper at a retailer location.

FIG. 5 illustrates an example computing environment in which example systems and methods illustrated herein can operate.

### DETAILED DESCRIPTION

This application describes example systems and methods for producing wallpaper at a retail location. In one example, a method can include displaying a plurality of wallpaper designs in a manner suitable for consumer viewing, receiving an order for a selected wallpaper design from the consumer, and printing, at the retail location, the selected wallpaper design onto a suitable substrate to thereby produce the wallpaper.

The following includes definitions of selected terms employed herein. The definitions include various examples and/or forms of components that fall within the scope of a term and that may be used for implementation. The examples are not intended to be limiting. Both singular and plural forms of terms may be within the definitions.

“Computer-readable medium”, as used herein, refers to a medium that participates in directly or indirectly providing signals, instructions and/or data. A computer-readable medium may take forms, including, but not limited to, non-volatile media, volatile media, and transmission media. Non-volatile media may include, for example, optical or magnetic disks and so on. Volatile media may include, for example, optical or magnetic disks, dynamic memory and the like. Transmission media may include coaxial cables, copper wire, fiber optic cables, and the like. Transmission media can also take the form of electromagnetic radiation, like those generated during radio-wave and infra-red data communications, or take the form of one or more groups of signals. Common forms of a computer-readable medium include, but are not limited to, a floppy disk, a flexible disk, a hard disk, a magnetic tape, other magnetic medium, a CD-ROM, other optical medium, punch cards, paper tape, other physical medium with patterns of holes, a RAM, a ROM, an EPROM, a FLASH-EPROM, or other memory chip or card, a memory stick, a carrier wave/pulse, and other media from which a computer, a processor or other electronic device can read. Signals used to propagate instructions or other software over a network, like the Internet, can be considered a “computer-readable medium.”

“Data store”, as used herein, refers to a physical and/or logical entity that can store data. A data store may be, for example, a database, a table, a file, a list, a queue, a heap, a memory, a register, and so on. A data store may reside in one logical and/or physical entity and/or may be distributed between two or more logical and/or physical entities.

“Design”, as used herein, refers to a graphic representation of any ornamental pattern, decorative work, and/or artistic work. The design may or may not be a repeating pattern.

“Digital image”, as used herein, refers to the type of image electronically stored by a computer in binary form, whether it be in random access memory, on a hard disk, or in any computer-readable medium known to be used by computers.

“Internet”, as used herein, refers to a collection of interconnected (public and/or private) networks that are linked together by a set of standard protocols (such as TCP/IP and HTTP) to form a global, distributed network. The term Internet also refers to intranets as well. While this term is intended to refer to what is now commonly known as the Internet, it is also intended to encompass variations which may be made in the future, including changes and additions to existing standard protocols.

“Logic”, as used herein, includes but is not limited to hardware, firmware, software and/or combinations of each to perform a function(s) or an action(s), and/or to cause a function or action from another component. For example, based on a desired application or needs, logic may include a software controlled microprocessor, discrete logic like an application specific integrated circuit (ASIC), a programmed logic device, a memory device containing instructions, or the like. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

An “operable connection”, or a connection by which entities are “operably connected”, is one in which signals, physical communication flow, and/or logical communication flow may be sent and/or received. Typically, an operable connection includes a physical interface, an electrical interface, and/or a data interface, but it is to be noted that an operable connection may include differing combinations of these or other types of connections sufficient to allow operable control.

“Printing”, as used herein, refers to forming a visual image of a design onto a substrate suitable for use as wallpaper or a sample of wallpaper. The visual image of the design can be formed by an image forming mechanism that utilizes various types of printing technologies such as ink jet, piezoelectric, thermal printing, laser printing, digital imaging, impact printing, or other available technologies. The term “printing” can also include forming an impression of the visual image of the design into the substrate such that the substrate is embossed with the visual image of the design.

“Registry”, as used herein, refers to a physical and/or logical entity that can store data related to, among other things, wallpaper designs. A registry may be, for example, a database, a table, a file, a list, a queue, a heap, a memory, a register, and so on. A registry may reside in one logical and/or physical entity and/or may be distributed between two or more logical and/or physical entities. A registry may be accessible by consumers.

“Signal”, as used herein, includes but is not limited to one or more electrical or optical signals, analog or digital, one or more computer or processor instructions, messages, a bit or bit stream, or other means that can be received, transmitted and/or detected.

“Software”, as used herein, includes but is not limited to, one or more computer or processor instructions that can be read, interpreted, compiled, and/or executed and that cause a computer, processor, or other electronic device to perform functions, actions and/or behave in a desired manner. The instructions may be embodied in various forms like routines, algorithms, modules, methods, threads, and/or programs including separate applications or code from dynamically linked libraries. Software may also be implemented in a variety of executable and/or loadable forms including, but not limited to, a stand-alone program, a function call (local and/or remote), a servelet, an applet, instructions stored in a memory, part of an operating system or other types of executable instructions. It will be appreciated by one of ordinary skill in the art that the form of software may be dependent on, for example, requirements of a desired application, the environment in which it runs, and/or the desires of a designer/programmer or the like. It will also be appreciated that computer-readable and/or executable instructions can be located in one logic and/or distributed between two or more communicating, co-operating, and/or parallel processing logics and thus can be loaded and/or executed in serial, parallel, massively parallel and other manners.

Suitable software for implementing the various components of the example systems and methods described herein include programming languages and tools like Java, Pascal, C#, C++, C, CGI, Perl, SQL, APIs, SDKs, assembly, firmware, microcode, and/or other languages and tools. Software, whether an entire system or a component of a system, may be embodied as an article of manufacture and maintained as part of a computer-readable medium as defined previously. Another form of the software may include signals that transmit program code of the software to a recipient over a network or other communication medium.

Some portions of the detailed descriptions that follow are presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and the like.

It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. Unless specifically stated otherwise, it is appreciated that throughout the description, terms like processing, computing, calculating, determining, displaying, or the like, refer to actions and processes of a computer system, logic, processor, or similar electronic device that manipulates and transforms data represented as physical (electronic) quantities.

“Suitable substrate”, as used herein, refers to any medium capable of being used as wallpaper, such as paper, vinyl sheeting, or contact paper. The suitable substrate may be provided in sheets or rolls.

“Wallpaper”, as used herein, refers to sheet-like substrate having a design or pattern printed thereon for use as a decorative wall covering. The term “wallpaper” can also include borders having a design or pattern printed thereon.

“Web site”, as used herein, refers to a computer system that serves informational content over a network using the standard protocols of the World Wide Web. Typically, a Web site corresponds to a particular Internet domain name and includes the content associated with a particular organization. As used herein, the term is generally intended to encompass both (i) the hardware/software server components that serve the informational content over the network, and (ii) the “back end” hardware/software components, including any non-standard or specialized components, that interact with the server components to perform services for Web site users.

“World Wide Web” (“WWW”), as used herein, refers generally to both (i) a distributed collection of interlinked, user-viewable hypertext documents (commonly referred to as Web documents or Web pages) that are accessible via the Internet, and (ii) the client and server software components which provide user access to such documents using standardized Internet protocols. Currently, the primary standard protocol for allowing applications to locate and acquire Web documents is HTTP, and the Web pages are encoded using HTML. However, the terms “Web” and “World Wide Web” are intended to encompass future markup languages and transport protocols which may be used in place of (or in addition to) HTML and HTTP.

“Visual image”, as used herein, refers to the wallpaper design that is viewable for consumer selection and that will be ultimately printed onto a suitable substrate. The term “visual image” does not include the binary image stored in the computer or computer-readable medium.

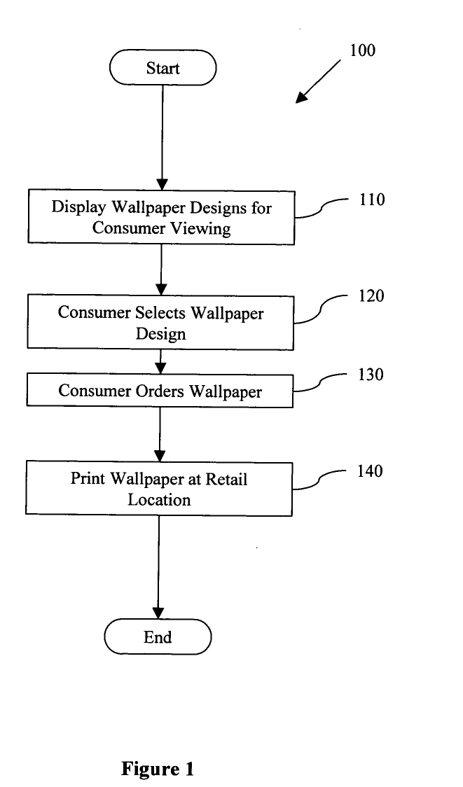

Example methods may be better appreciated with reference to the flow diagrams of FIGS. 1-4. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Furthermore, additional and/or alternative methodologies can employ additional, not illustrated blocks.

In the flow diagrams, blocks denote “processing blocks” that may be implemented with logic. A flow diagram does not depict syntax for any particular programming language, methodology, or style (e.g., procedural, object-oriented). Rather, a flow diagram illustrates functional information one skilled in the art may employ to develop logic to perform the illustrated processing. It will be appreciated that in some examples, program elements like temporary variables, routine loops, and so on are not shown. It will be further appreciated that electronic and software applications may involve dynamic and flexible processes so that the illustrated blocks can be performed in other sequences that are different from those shown and/or that blocks may be combined or separated into multiple components. It will be appreciated that the processes may be implemented using various programming approaches like machine language, procedural, object oriented and/or artificial intelligence techniques.

FIG. 1 illustrates one example of a method of producing wallpaper at a retail location 100. In one embodiment, wallpaper can be produced at the retail location in a “made-to-order” fashion where the wallpaper can be produced “on demand.” For example, the method 100 can include displaying a plurality of wallpaper designs in a manner suitable for consumer viewing (block 110). In one embodiment, the wallpaper designs can be provided in a registry.

In one embodiment, the wallpaper designs can be displayed in a book at the retail location. In another embodiment, the wallpaper designs can be displayed on a video display unit, such as a computer monitor or LCD display, at the retail location. It will be appreciated that other forms of media may be used to enable consumers to view the wallpaper designs such as wall displays.

Optionally, upon request by the consumer, a sample of the design can be printed for the consumer. The sample of the wallpaper design can allow the consumer to take the design sample home and evaluate it with the room's existing or new decoration, accessory items, and/or paint. Optionally, the design sample may be printed on paper having a low-tack adhesive backing which can allow the consumer to temporarily stick the sample design on the wall permitting the consumer to examine the sample design from a distance. One suitable example of a paper having a low-tack adhesive backing is a Post-it® Self-Stick Easel Pad sheet made by 3M of Minneapolis, Minn.

After evaluating the wallpaper designs, the consumer can make a final decision and select a specific wallpaper design (block 120). Once a specific wallpaper design has been selected and if the consumer is aware of the amount required to complete his/her wallpapering project, the consumer can make a request to order a desired amount of wallpaper having the selected design printed thereon (block 130). The desired amount can be, for example, an amount required to complete the consumer's wallpapering project. It will be appreciated that the consumer can order the selected wallpaper design through one or more of, a user interface, a direct interaction over a telecommunications device, an in-person consultation, an electronic communication, and a written communication.

Optionally, if the consumer is unaware of the amount required to complete his/her wallpapering project, the consumer can supply the retailer with the dimensions of the room or wall to be covered by the wallpaper. Once supplied with the dimensions of the room or wall to be covered by the wallpaper, the retailer can calculate the amount required to complete the consumer's wallpapering project using a software program or a quick-reference card.

After the consumer orders the amount required to complete the consumer's wallpapering project, the order can be transmitted to a printing site for producing the wallpaper. In one embodiment, the printing site is located on-site at the retail location. Accordingly, once the order is received and processed at the printing site, the selected wallpaper design can then be printed onto a suitable substrate to produce the wallpaper (block 140). Optionally, a protective coating may be applied over the printed design. Methods of printing the selected wallpaper design onto the suitable substrate to produce the wallpaper will be further described below.

In one embodiment, the wallpaper can be produced at the printing site within a relatively short period of time of receiving the order (e.g., one hour). Obviously, a relatively short amount of time can include less than or more than one hour depending on the circumstances. Having the capabilities to produce the wallpaper in relatively short period of time allows the consumer to stay in the retail location and continue to after placing the order, and then pick up the wallpaper when it is completed. Optionally, the consumer can supply the retailer with his/her mobile, pager, or home phone number, which can be entered into a contact system. Once the order is completed, the contact system can automatically generate a phone call to the consumer or the vendor may personally call the consumer to notify the consumer when the order is ready for pick up. Alternatively, the retailer may utilize other means to notify the consumer that the order is ready for pick-up such as a “restaurant” pager or similar device.

In one embodiment according to the method described above and illustrated schematically in FIG. 1, the retail location may include one or more self-sufficient wallpaper “booths” each having a computer, a video display and/or books to display plurality of wallpaper designs, and a printer (hereinafter referred to as a “wallpaper booth”). In this embodiment, consumers may view the wallpaper designs, print samples of the wallpaper designs, and place orders for specific wallpaper designs all within the wallpaper booth.

In another embodiment according to the method described above and illustrated schematically in FIG. 1, the retail location may include wallpaper booths containing only a video display and/or books to permit the consumer to view the wallpaper designs. In this embodiment, each wallpaper design may be associated with a number or SKU thus enabling the consumer to visit the wallpaper counter and request samples or place orders for specific wallpaper designs.

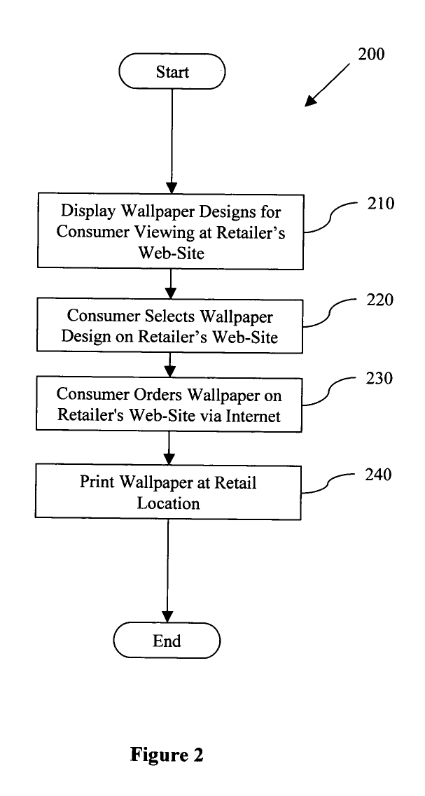

FIG. 2 illustrates another example of a method of producing wallpaper at a retail location 200. In one embodiment, wallpaper can be produced at the retail location in a “made-to-order” fashion where the wallpaper can be produced for pick-up by the consumer or delivery to the consumer. For example, the method 200 can include displaying a plurality of wallpaper designs in a manner suitable for consumer viewing at a location remote from the retail location (e.g., the consumer's home of office) (block 210). In one embodiment, the wallpaper designs can be provided in a registry.

In one embodiment, the wallpaper designs can be displayed in a book that the consumer borrows from the retailer. In another embodiment, the wallpaper designs can be displayed on a video display unit, such as a computer monitor or LCD display, on the retailer's web site via the Internet.

Optionally, the consumer can print sample wallpaper designs on demand. In one embodiment, the consumer can print a sample wallpaper design on regular paper using his/her own dot matrix, ink jet, or laser printer. The sample of the wallpaper design can allow the consumer to take the design sample home and evaluate it with the room's existing or new decoration, accessory items, and/or paint. Optionally, the design sample may be printed on paper having a low-tack adhesive backing which can allow the consumer to temporarily stick the sample design on the wall permitting the consumer to examine the sample design from a distance. One suitable example of a paper having a low-tack adhesive backing is a Post-its Self-Stick Easel Pad sheet made by 3M of Minneapolis, Minn.

After evaluating the designs, the consumer can make a final decision and select a specific design (block 220). Once a specific design has been selected and if the consumer is aware of the amount required to complete his/her wallpapering project, the consumer can make an on-line request to order a desired amount of wallpaper having the selected design printed thereon on the retailer's web site via the Internet. The desired amount can be, for example, an amount required to complete the consumer's wallpapering project.

Optionally, if the consumer is unaware of the amount required to complete his/her wallpapering project, the retailer's web site can include a “wallpaper calculator” (using software) that can calculate the amount required to complete the consumer's wallpapering project when supplied with dimensions of the room or wall to be covered by the wallpaper. Once supplied with the dimensions of the room or wall to be covered by the wallpaper, the wallpaper calculator can calculate the amount required to complete the consumer's wallpapering project.

After the consumer orders the amount required to complete the consumer's wallpapering project, the order can be transmitted to a printing site, via the Internet, for producing the wallpaper. In one embodiment, the printing site is located on-site at the retail location. Accordingly, once the order is received and processed at the printing site, the selected wallpaper design can then be printed onto a suitable substrate to produce the wallpaper (block 240). Optionally, a protective coating may be applied over the printed design. Methods of printing the selected wallpaper design onto the suitable substrate to produce the wallpaper will be further described below.

In one embodiment, the wallpaper can be produced at the printing site within a relatively short period of time of receiving the order (e.g., one hour). Obviously, a relatively short amount of time can include less than or more than one hour depending on the circumstances. Optionally, the wallpaper may be printed on the same day as it was ordered, and may be delivered to the consumer at a designated address on the next day via an express delivery service. Alternatively, the web-site may prompt the consumer to enter in the consumer's mobile, pager, or home phone number so that a representative or a recorded message may notify the consumer when the order is ready for pick up.

The methods discussed above allow a wallpaper retailer to provide a larger selection of wallpaper designs while decreasing the amount of wallpaper stocked in inventory. Since the wallpaper can be printed on demand, the retailer does not need to keep any of the wallpaper designs in inventory, avoiding all issues associated with inventory. Further, just-in-time (JIT) principles may be utilized because of the timely processing of orders. Since the amount of wallpaper in inventory is decreased, the revenue per square foot is increased.

Also, consumer satisfaction is increased because there is a large variety to choose from and an instant supply of the selected wallpaper. Additionally, the consumer can order a specific amount of wallpaper. This can be a benefit to a consumer when a wallpapering project requires slightly more than an even number of rolls and the consumer has to purchase the extra roll resulting in a large portion of that roll being wasted. Since customer satisfaction is higher, the retailer is able to increase customer retention. The retailer is also able to keep a database of customer contact information and previous ordering habits through the electronic ordering method. Each of these advantages, in turn, can increase the retailer 's profitability.

In another example, a method is provided to produce customizable decorative wallpaper sheets or panels, which provide a coherent design not having a repeating pattern when the sheets or panels of wallpaper are aligned side by side in the correct order. The decorative image or design may comprise, for example, a landscape, a cityscape, a still life, an abstract or any other design that is aesthetically pleasing or required for a particular purpose. Importantly, although the wallpaper does not include a repeating pattern that must be matched in side-by-side adhered sheets, as in prior art wallpapers, this does not preclude the invention's repetitive use of certain images, for example, images of a particular word, or a particular image. A commercial establishment may, for example, wish to intersperse its trademark at various points in the scene depicted in the wallpaper. However, the placement of these words or images, although they may be in a repetitive sequence, do not constitute the type of repetitive pattern that is necessary in prior art wallpapers to enable alignment of the papers to produce a coherent design on a wall.

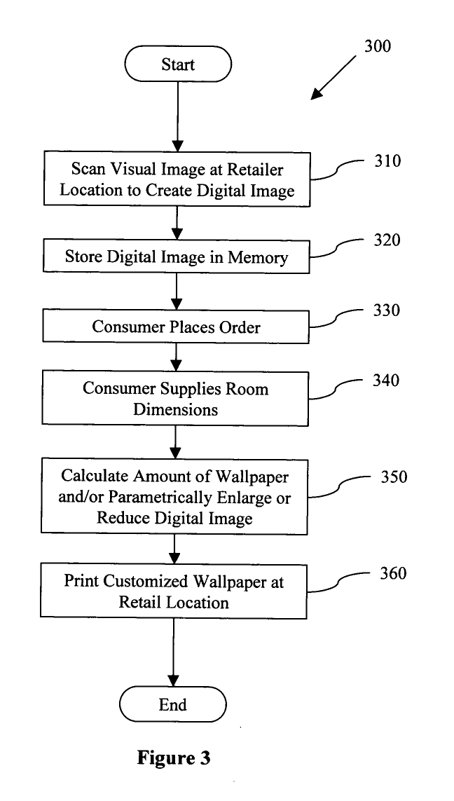

FIG. 3 illustrates one example of a method of producing customized wallpaper at a retail location. The method 300 can include scanning a photograph, picture, drawing, document or other suitable visual image using any mechanism suitable for obtaining a digital or electronic representation of the image to thereby produce a digital image of the visual image (block 310). The digital image can then be stored in a computer-readable medium such as memory (block 320). Optionally, the retailer and/or consumer may edit the digital image using any conventional photo-editing software and store the edited digital image in memory. Alternatively, the consumer may already have the visual image stored as a digital image and, thus, may provide such digital image directly to the retailer.

Once the digital image is stored in memory, a sample of the digital image can be printed upon request by the consumer to allow the consumer to examine a printed copy of the digital image to ensure that the scanning of the visual image was error-free. If the visual image is not error-free, the digital image may be edited as discussed above.

Once the consumer has accepted that the digital image is an accurate depiction of the visual image, the consumer can place an order at the retail location for the customized wallpaper (block 330). The retailer can then ask the consumer to supply the dimensions of the room or wall to be covered by the customized wallpaper so that the retailer can calculate the amount of customized wallpaper required for the project and determine whether the digital image needs to be parametrically enlarged or reduced to fit the room or wall dimensions (block 340). Once supplied with the dimensions of the room or wall to be covered by the customized wallpaper, the retailer can calculate the amount required to complete the consumer's wallpapering project and parametrically enlarge or reduce the digital image to fit the room or wall dimensions entered using a software program (block 350).

The order for the customized wallpaper can then be transmitted to a printing site for producing the customized wallpaper, which is located on-site at the vendor's place of business. Accordingly, the visual image can be printed on a suitable substrate to produce the customized wallpaper in the amount required based upon the dimensions supplied by the consumer (block 360). Optionally, a protective coating may be applied over the printed design. Methods of printing the visual image onto the suitable substrate to produce the customized wallpaper will be further described below.

In one embodiment, the customized wallpaper can be produced at the printing site within a relatively short period of time of receiving the order (e.g., one hour). Obviously, a relatively short amount of time can include less than or more than one hour depending on the circumstances. Optionally, the consumer can supply the retailer with his/her mobile, pager, or home phone number, which can be entered into a contact system. Once the order is completed, the contact system can automatically generate a phone call to the consumer or the vendor may personally call the consumer to notify the consumer when the order is ready for pick up. Alternatively, the retailer may utilize other means to notify the consumer that the order is ready for pick-up such as a “restaurant” pager or similar device.

In one embodiment according to the method described above and illustrated schematically in FIG. 3, the retail location may include self-sufficient wallpaper booths each having a scanner, a computer, a video display, and a printer (“wallpaper booth”). In this embodiment, consumers can scan a visual image into a digital image themselves, print samples of the digital image, and place orders for customized wallpaper designs all within the wallpaper booth.

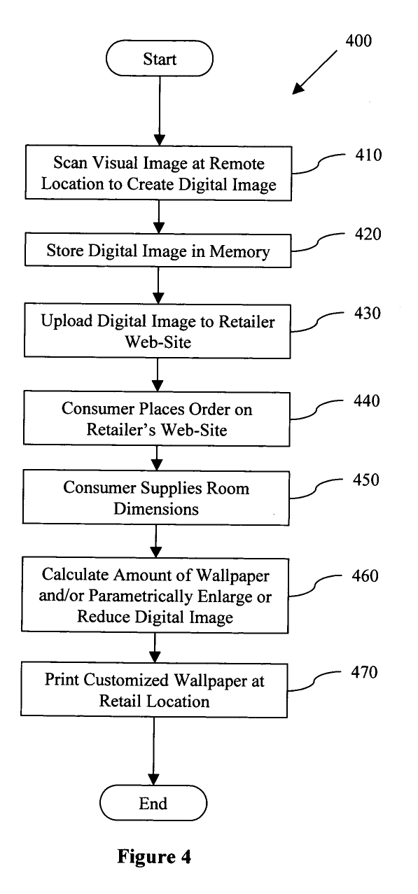

FIG. 4 illustrates another example of a method of producing customized wallpaper at a retail location. The method 400 can include scanning a photograph, picture, drawing, document or other suitable visual image using any mechanism suitable for obtaining a digital or electronic representation of the image to thereby produce a digital image of the visual image (block 410). In one embodiment, the scanning can be conducted at a location remote from the retail location (e.g., the consumer's home or office). The digital image can then be stored in a computer-readable medium such as memory (block 420). Alternatively, the consumer may already have the visual image stored as a digital image.

Optionally, the consumer may edit the digital image using any conventional photo-editing software and store the edited digital image in memory. To examine a printed copy of the digital image to ensure that the scanning of the visual image was error-free, a sample of the digital image can be printed by the consumer. If the visual image is not error-free, the digital image may be edited as discussed above.

Once the digital image is stored in memory and the consumer has accepted that the digital image is an accurate depiction of the visual image, the digital image can then be uploaded to the retailer's web-site via the Internet or any other means known in the art an stored in memory on the retailer's web-site server (block 430). The consumer can then place an order for the customized wallpaper on the retailer's web-site via the Internet (block 440).

The retailer's web site can then prompt the consumer to supply the dimensions of the room or wall to be covered by the customized wallpaper so that the retailer can calculate the amount of customized wallpaper required for the project and determine whether the digital image needs to be parametrically enlarged or reduced to fit the room or wall dimensions (block 450). Once supplied with the dimensions of the room or wall to be covered by the customized wallpaper, a software program can calculate the amount required to complete the consumer's wallpapering project and parametrically enlarge or reduce the digital image to fit the room or wall dimensions entered (block 460).

After the consumer orders the customized wallpaper, the order can be transmitted to a printing site, via the Internet, for producing the customized wallpaper. In one embodiment, the printing site is located on-site at the retail location. Accordingly, once the order is received and processed at the printing site, the selected design can then be printed onto a suitable substrate to produce the wallpaper (block 470). Optionally, a protective coating may be applied over the printed design. Methods of printing the selected wallpaper design onto the suitable substrate to produce the wallpaper will be further described below.

In one embodiment, the wallpaper can be produced at the printing site within a relatively short period of time of receiving the order (e.g., one hour). Obviously, a relatively short amount of time can include less than or more than one hour depending on the circumstances. Optionally, the wallpaper may be printed on the same day as it was ordered, and may be delivered to the consumer at a designated address on the next day via an express delivery service. Alternatively, the web-site may prompt the consumer to enter in the consumer's mobile, pager, or home phone number so that a representative or a recorded message may notify the consumer when the order is ready for pick up.

An example of how the customized digital image may be printed as customized wallpaper is shown and described in U.S. Pat. No. 6,354,212 issued to Krinsky, which is hereby incorporated by reference in its entirety.

The wallpaper, standard or customized, may be printed utilizing any of a variety of existing technologies. Suitable printing technologies include, but are not limited to, ink jet, piezoelectric, thermal printing, laser printing, digital imaging, impact printing, or other available technologies.

One specific example of a printing technology that can be used is “raster image processing”. In this technique, the digital image can be downloaded to a raster image processor that creates a mirror image of a visual design corresponding to the modified digital image on a substrate. The mirror image of the visual design is then transferred onto a suitable wallpaper substrate by heat lamination. A protective coating may optionally be applied over the printed design.

In an alternative printing method, printing includes modifying the digital image into a visual image, printing a reverse image of the visual image onto transfer paper, heat laminating the transfer paper image to a wallpaper substrate, applying a wet-transfer process to the combined transfer paper and wallpaper substrate sandwich; and finally removing the transfer paper and excess toner from the wallpaper substrate to produce a wallpaper with the printed image.

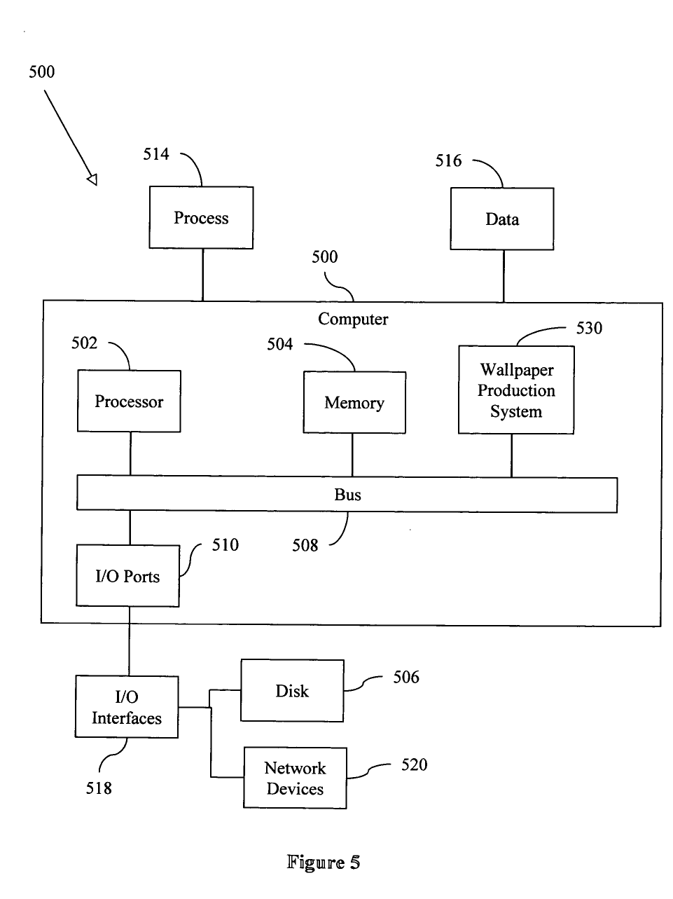

FIG. 5 illustrates a computer 500 that includes a processor 502, a memory 504, a disk 506, input/output ports 510, and a network interface 512 operably connected by a bus 608. The computer 500 may also include a wallpaper production system 530 similar to the example systems described herein. The wallpaper production system 530 may include, for example, a logic that performs the example executable methods described herein. It is to be appreciated that other computers may also be employed with the systems and methods described herein. The wallpaper production system 530 may be permanently and/or removably attached to computer 500.

The processor 502 can be a variety of various processors including dual microprocessor and other multi-processor architectures. The memory 504 can include volatile memory and/or non-volatile memory. The non-volatile memory can include, but is not limited to, read only memory (ROM), programmable read only memory (PROM), electrically programmable read only memory (EPROM), electrically erasable programmable read only memory (EEPROM), and the like. Volatile memory can include, for example, random access memory (RAM), synchronous RAM (SRAM), dynamic RAM (DRAM), synchronous DRAM (SDRAM), double data rate SDRAM (DDR SDRAM), and direct RAM bus RAM (DRRAM).

The disk 506 can include, but is not limited to, devices like a magnetic disk drive, a floppy disk drive, a tape drive, a Zip drive, a flash memory card, and/or a memory stick. Furthermore, the disk 506 can include optical drives like, a compact disc ROM (CD-ROM), a CD recordable drive (CD-R drive), a CD rewriteable drive (CD-RW drive) and/or a digital versatile ROM drive (DVD ROM). The memory 504 can store processes 514 and/or data 516, for example. The disk 506 and/or memory 504 can store an operating system that controls and allocates resources of the computer 500.

The bus 508 can be a single internal bus interconnect architecture and/or other bus architectures. The bus 508 can be of a variety of types including, but not limited to, a memory bus or memory controller, a peripheral bus or external bus, and/or a local bus. The local bus can be of varieties including, but not limited to, an industrial standard architecture (ISA) bus, a microchannel architecture (MSA) bus, an extended ISA (EISA) bus, a peripheral component interconnect (PCI) bus, a universal serial (USB) bus, and a small computer systems interface (SCSI) bus.

The computer 500 interacts with input/output devices 518 via input/output ports 1010. Input/output devices 518 can include, but are not limited to, a keyboard, a microphone, a pointing and selection device, cameras, video cards, displays, and the like. The input/output ports 510 can include but are not limited to, serial ports, parallel ports, and USB ports.

The computer 500 can operate in a network environment and thus is connected to network devices 520 by a network interface (NIC) 512. Through the network devices 520, the computer 500 may interact with a network. Through the network, the computer 500 may be logically connected to remote computers. The networks with which the computer 500 may interact include, but are not limited to, a local area network (LAN), a wide area network (WAN), and other networks. The network interface 512 can connect to LAN technologies including, but not limited to, fiber distributed data interface (FDDI), copper distributed data interface (CDDI), Ethernet/IEEE 802.3, token ring/IEEE 802.5, wireless/IEEE 802.11, Bluetooth, and the like. Similarly, the network interface 512 can connect to WAN technologies including, but not limited to, point to point links, circuit switching networks like integrated services digital networks (ISDN), packet switching networks, and digital subscriber lines (DSL).

In one example, a system may include a processor. The system may include a memory operably connected to the processor, where the processor can access the memory. The system may also include a logic operably connected to the processor, where the logic is configured to display a plurality of wallpaper designs in a manner suitable for consumer viewing, receive an order for a selected wallpaper design from the consumer; and print, at a retail location, the selected wallpaper design onto a suitable substrate for decorative use.

In another example, a computer-readable medium may store processor executable instructions operable to perform a method that includes displaying a plurality of wallpaper designs in a manner suitable for consumer viewing. The method may also include receiving an order for a selected wallpaper design from the consumer. The method may also include printing, at a retail location, the selected wallpaper design onto a suitable substrate for decorative use. While the above method is described being stored on a computer-readable medium, it is to be appreciated that other example methods described herein can also be stored on a computer-readable medium.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicants' general inventive concept. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Gamer, A Dictionary of Modern Legal Usage 624 (2d. Ed. 1995).

1. A method of producing wallpaper in a retail location, comprising:
displaying a plurality of wallpaper designs in a manner suitable for consumer viewing;
receiving an order for a selected wallpaper design from the consumer; and
at the retail location, printing the selected wallpaper design onto a suitable substrate to thereby produce the wallpaper.

2. The method of claim 1 further comprising, before the receiving step, printing a sample of a selected wallpaper design for consumer use.

3. The method of claim 2 wherein the sample is printed at the retail location.

4. The method of claim 1 further comprising the step of calculating an amount of wallpaper required by the consumer based on room dimensions supplied by the consumer.

5. The method of claim 1 further comprising applying a protective layer to the substrate after the selected wallpaper design is printed thereon.

7. The method of claim 1 wherein the plurality of wallpaper designs are displayed in a book.

8. The method of claim 1 wherein the plurality of wallpaper designs are displayed on a video display unit that is in electrical communication with computer-readable medium containing stored digital images of the wallpaper design.

9. The method of claim 8 wherein the video display unit is a computer monitor provided in the retail location.

10. The method of claim 9 wherein the consumer orders the selected wallpaper design via a user-interface provided with the computer monitor.

11. The method of claim 8 wherein the video display unit is a computer monitor provided in a location remote from the retail location and access to the computer-readable medium containing the stored digital images of the design is via the Internet.

12. The method of claim 1 wherein the consumer orders the selected wallpaper design via the Internet.

13. The method of claim 1 wherein the consumer orders the selected wallpaper design through one or more of, a user interface, a direct interaction over a telecommunications device, an in-person consultation, an electronic communication, and a written communication.

14. The method of claim 1 wherein the printing can be accomplished by a printing technology selected from the group consisting of ink jet, piezoelectric, thermal, laser, impact, raster image processing, and embossing.

15. The method of claim 1 wherein the wallpaper is completed and available for consumer pick-up within an hour of receiving the order for the selected wallpaper design.

16. A computer-readable medium storing processor executable instructions operable to perform a method, the method comprising:
displaying a plurality of wallpaper designs in a manner suitable for customer viewing,
receiving an order for a selected wallpaper design from the consumer, and
printing, at the retail location, the selected wallpaper design onto a suitable substrate to thereby produce the wallpaper.

17. A system, comprising:
a processor;
a memory operably connected to the processor, where the processor can access the memory; and
a logic operably connected to the processor, where the logic is configured to:
display a plurality of wallpaper designs in a manner suitable for customer viewing,
receive an order for a selected wallpaper design from the consumer, and
print, at the retail location, the selected wallpaper design onto a suitable substrate to thereby produce the wallpaper.

18. A system, comprising:
means for displaying a plurality of wallpaper designs in a manner suitable for customer viewing,
means for receiving an order for a selected wallpaper design from the consumer, and
means for printing, at the retail location, the selected wallpaper design onto a substrate to thereby produce the wallpaper.
